(19) United States
(12) Patent Application Publication
(10) Pub. No.: US 2020/0401019 A1
(43) Pub. Date: Dec. 24, 2020

(54) MULTI-APERTURE CAMERA SYSTEM FOR INSPECTIONS

(71) Applicant: Deep Analytics, LLC, Montpelier, VT (US)

(72) Inventors: Gregory Hewitt, Northfield, VT (US); Daniel Cote, Hartland, VT (US); Thomas Hryckiewicz, Milton, VT (US)

(21) Appl. No.: 16/946,486

(22) Filed: Jun. 24, 2020

Related U.S. Application Data
(60) Provisional application No. 62/865,423, filed on Jun. 24, 2019.

(51) Int. Cl. G03B 17/56; F16M 11/10; F16M 13/04

(52) U.S. Cl. CPC G03B 17/561; H04M 1/04; F16M 13/04; F16M 11/10

(57) ABSTRACT

A multi-aperture camera system is provided that facilitates the visual inspection of areas or surfaces via a handheld pole camera operated by a user. The system includes a camera head connected to a pole, which has a handle with controls for the camera, a grip, and a screen support. The pole is extendable and the camera head is rotatable about the pole. The camera head includes one or more camera modules, an interface board, a computer module, illumination lights, which may be white light and IR, indication LEDs, and a high-speed data interface. The system may also include a remote-control interface, a power interface, heat sinks, compression stacks, and an enclosure for the camera head.

### FIELD OF THE INVENTION

The present invention generally relates to equipment for conducting visual inspections. In particular, the present invention is directed to a multi-aperture camera system for inspections.

### BACKGROUND

Visually inspecting areas that are dark, difficult to access, and/or hazardous can be more easily and safely accomplished with the use of a camera extended on a pole. However, pole cameras have generally been of low resolution, do not stream video and capture images, and are not convenient to use in many situations requiring visual inspection, especially for potentially dangerous items.

### SUMMARY OF THE DISCLOSURE

A system for facilitating a visual inspection includes a pole, the pole being extendable and having a distal end and a proximal end, and a gimbal attached to the distal end of the pole. A handle is on the proximal end of the pole, the handle including a screen support, a base, an arm support, and a grip extending from the base, the grip including a plurality of controls. A camera head is attached to the gimbal, and the camera head includes a plurality of camera modules and an interface board, wherein at least some functions of the camera head are controlled by the plurality of controls, and wherein images captured by the plurality of camera modules are sent through the pole to a data port near the proximal end of the pole.

In another embodiment, a camera head for facilitating a visual inspection includes an enclosure that contains a camera module, a plurality of lights for illuminating an area for the camera module, a high-speed data interface, a heatsink component, an interface board including a computer module and in communication with the camera module, the plurality of lights, and the high-speed data interface, and a compression stack, wherein the camera module, the interface board, the heatsink component, and the plurality of lights are mechanically interfaced only with compression. A gimbal connector passes through the enclosure and is in thermal contact with the heatsink component.

In another embodiment, a system for facilitating a visual inspection includes a pole that is extendable and has a distal end and a proximal end, a handle on the proximal end of the pole with a grip and an arm support, and a camera head in an enclosure and pivotably attached to the distal end of the pole. The camera head includes a camera module, a heat sink extending through the enclosure, a compression stack, a light positioned to illuminate areas in view of the camera module, and an interface board, wherein the camera module, the interface board, the light, and the heat sink are mechanically interfaced only by compression.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a perspective view of a multi-aperture camera system in accordance with an embodiment of the present invention;

FIG. 2A is a perspective view of a distal portion of the system shown in FIG. 1 with a camera head attached to an end of a pole via a gimbal mechanism in accordance with an embodiment of the present invention;

FIG. 2B is a perspective view of the distal portion shown in FIG. 2A with the camera head rotated to another orientation;

FIG. 3A is a perspective view of a gimbal mechanism for attaching the camera head to the pole;

FIG. 3B is a perspective view of the gimbal mechanism shown in FIG. 3A with the gimbal mount detached;

FIG. 4 is a front view of a camera head in accordance with an aspect of an embodiment of the present invention;

FIG. 5 is a cut-away perspective view of a camera head in accordance with an aspect of an embodiment of the present invention;

FIG. 6 is a perspective view of a camera head in an enclosure in accordance with an embodiment of the present invention;

FIG. 7 is a partially exploded view of the camera head of FIG. 6;

FIG. 8 is a cut-away side view of the distal end of a pole in accordance with an aspect of the present invention;

FIGS. 9A-9B are perspective views of a handle at the proximal end of the pile in accordance with an aspect of the present invention;

FIG. 10 is an exemplary screen view of an app for controlling the camera system;

FIG. 11 is another exemplary screen view of the app for controlling the camera system; and

FIG. 12 depicts an operator using a camera system of the present invention to perform a visual inspection.

### DESCRIPTION OF THE DISCLOSURE

A handheld, multi-aperture pole camera operated by a user facilitates the visual inspection of areas or surfaces. The system includes a camera head connected to a pole, which has a grip and a screen support. The pole is extendable and the camera head is rotatable about the pole. The camera head may include a plurality of camera modules, an interface board, a computer module, illumination LEDs, which may include white light and IR, indication LEDs, and a high-speed data interface. The system may also include a remote-control interface, a power interface, and an enclosure for the camera head. The camera system allows for the visual inspection of dark, difficult to access, and/or hazardous areas and for data/images to be viewed and sent to other systems for analysis.

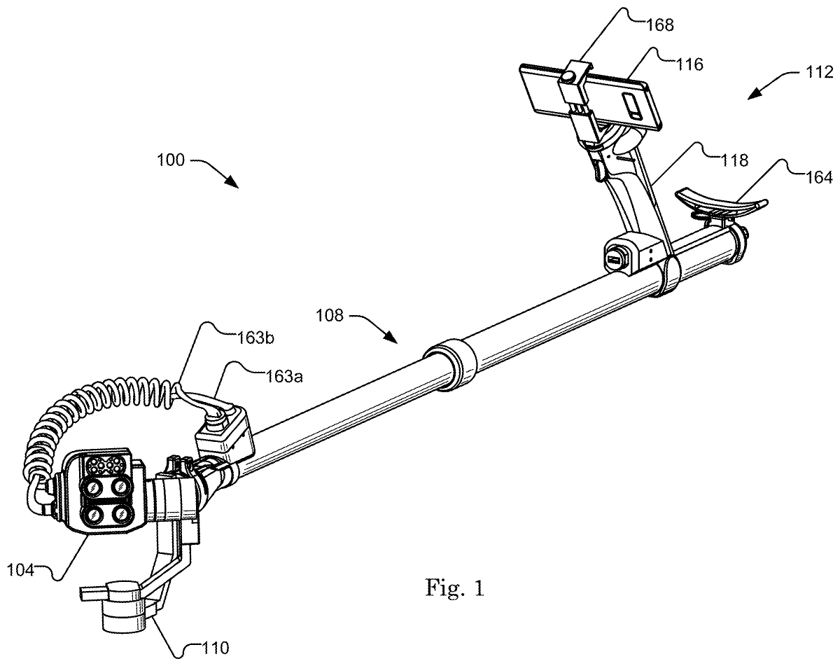

In an embodiment, a multi-aperture pole camera system, such as multi-aperture pole camera system 100 shown in FIG. 1, includes a camera head 104 connected to a distal end of a pole 108 via a gimbal mechanism 110. Pole 108 includes a handle portion 112 near a proximal end of pole 108, which includes a grip 118, an arm support 164, and a screen holder 168 for securing a screen 116. Screen 116 and handle 112 include controls for operating camera head 104, and images captured by camera head 104 can be displayed on screen 116.

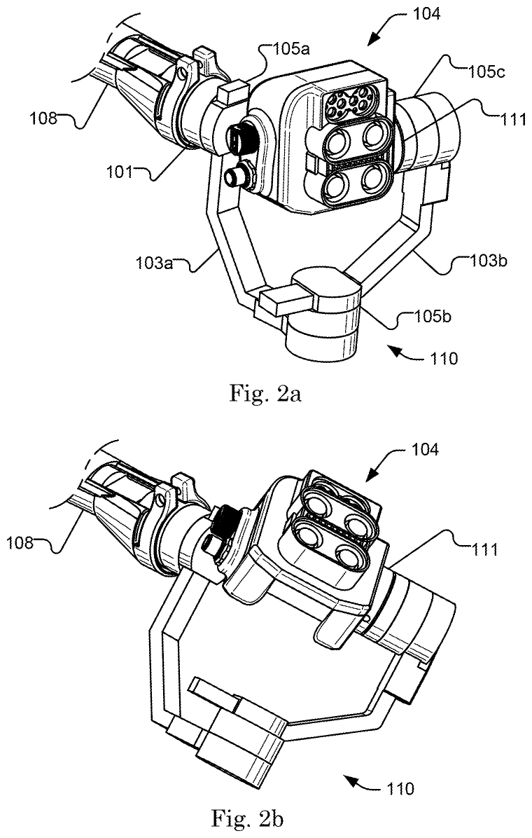

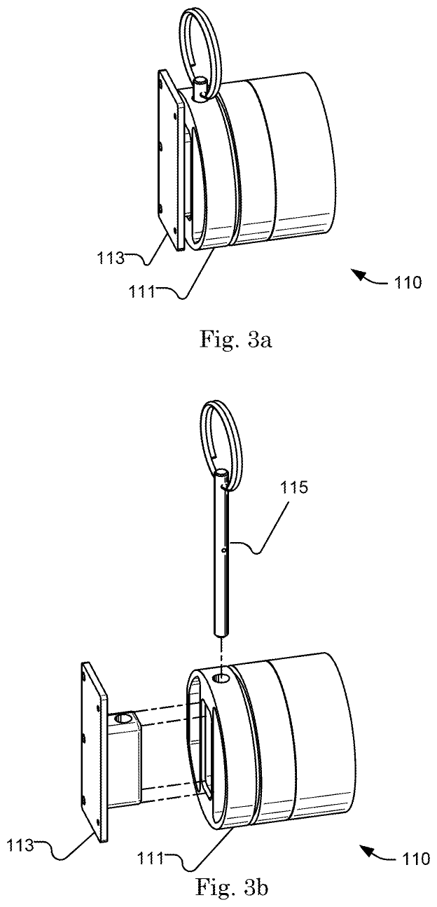

As can be seen in FIGS. 2A-2B, camera head 104 is connected to pole 108 via gimbal mechanism 110, which includes a camera attachment portion 111 (shown in more detail in FIGS. 3A-3B) which may include a slot configured to accept a portion of a camera-gimbal mount 113. The opposite side of camera-gimbal mount 113 is secured to camera head 104, and when camera-gimbal mount 113 is inserted into the slot of camera attachment portion 111, it may be secured by any suitable mechanism such as pin 115.

Gimbal mechanism 110 further includes a pole connector 101, one or more arms 103 (e.g., 103a, 103b) connecting pole connector 101 to camera attachment portion 111. One or more connection points 105 (e.g., 105a-105c) may be pivotable, thus allowing camera 104 to be oriented in any direction.

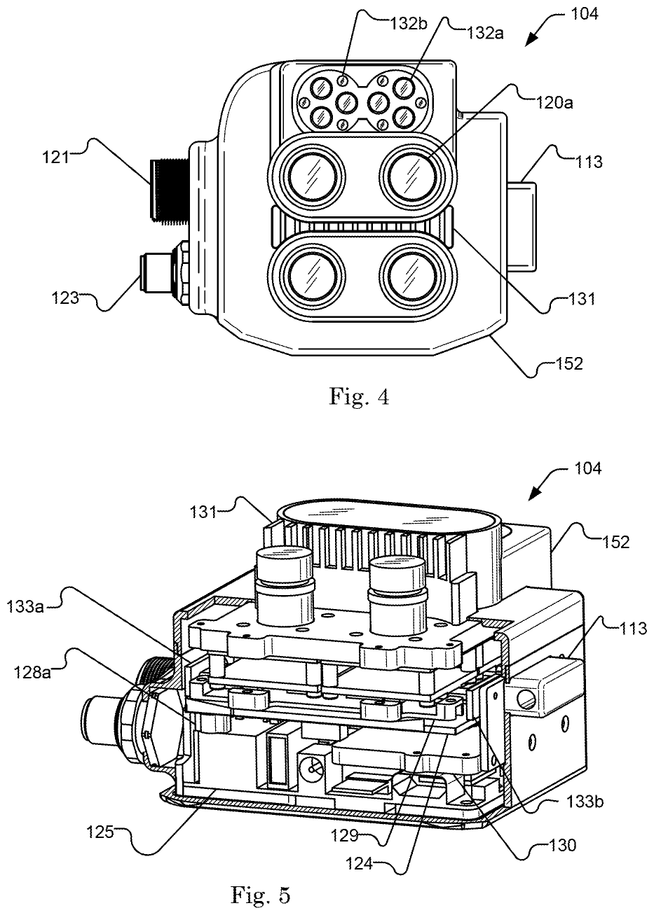

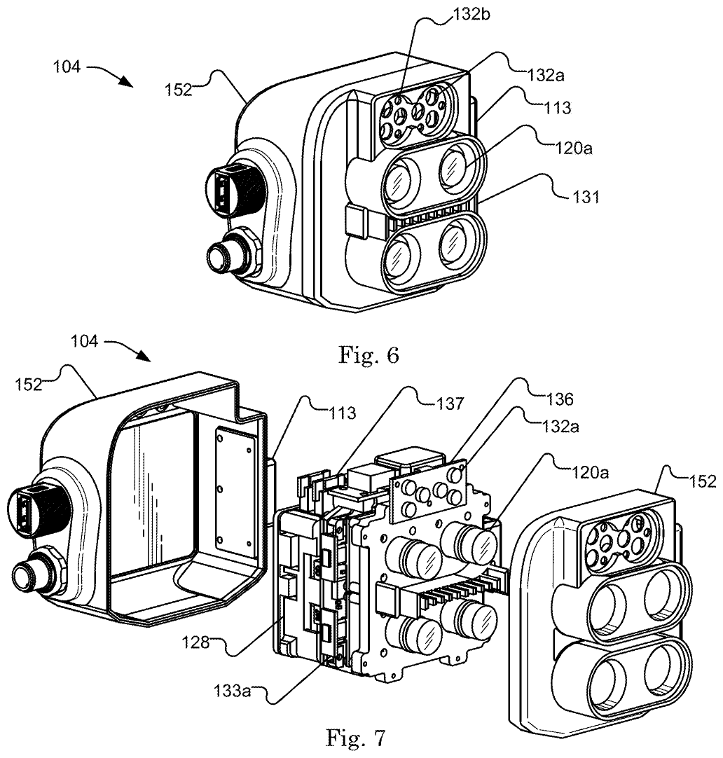

Camera head 104 includes, in addition to camera-gimbal mount 113 and as shown in FIGS. 4-7, a plurality of camera modules 120 (e.g., 120a), an interface board 124 that includes a computer module, one or more compression stacks 128 (e.g., 128a), a camera heat sink 129, a plurality of illumination LEDs 132 (e.g., 132a, 132b), which may include white light (132a) and IR (132b), an indication LED board 136, and a high speed data/power interface 140. System 100 may also include a remote-control interface, a USB connector 121, a power and button control connector 123, a single board computing device 125, one or more USB C boards 133 (e.g., 133a-133b), and one or more USB A boards 137 (FIG. 7). Further, in addition to camera heat sink 129, camera head 104 may include a single board computing device heat sink 130 and/or a camera cage heat sink 131. The plurality of camera modules may include acrylic glass or other suitable lens protectors (not shown). In a preferred embodiment, there may be four camera modules, which allow for high resolution images and videos to be recorded. In an alternative embodiment, the camera head may include three color cameras and one IR camera. In another alternative embodiment, the camera head may include a single camera capable of operating in a continuous shooting or burst mode in order to record high resolution images.

Having a plurality of camera modules 120 enables high resolution images and videos to be acquired while the arrangement of components allows camera head 104 to remain compact. Interface board 124 provides an interface for the plurality of camera modules 120. LEDs 132 provide illumination around camera head 104 for obtaining images in dark areas. Indication LED board 136 may be used to provide confirmation of the activation, readiness, or inactivation of various components. The interfaces allow for transmission of high-speed data/power so that camera head 104 can be connected to other components of multi-aperture pole camera system 100, such as the battery, controls, and screen 116.

In a preferred embodiment, an enclosure 152 for camera head 104 encompasses the components of camera head 104 and preferably is designed and configured to tightly compress electronics in camera head 104 for shock and vibration resistance, as well as to facilitate heat transfer. In addition, heat sink 130 is preferably in thermal contact with camera-gimbal mount 113 so that heat is transferred from internal camera head components to camera-gimbal mount 113, which, when attached to camera attachment portion 111 of gimbal mechanism 110, serves to conduct heat out of camera head 104. To that end, camera attachment portion 111 may be made with aluminum or other suitable materials that assist with conducting heat away from camera-gimbal mount 113.

In a preferred embodiment, the above described components of camera head 104 are arranged in a compact manner and may be mechanically interfaced only with compression (i.e., without the use of screws or similar securement mechanisms) via placement of compression stacks 128 (e.g., 128a) to simplify assembly and increase ruggedness. Compression stacks 128 provide wire routing and a pseudo-hard interface for transitioning shock/vibration through components evenly.

Interface board 124 provides a USB 3.0 “super speed” or other suitable interface for connecting camera modules 120 to the computing module. Interface board 124 also has a micro controller that can disable and enable power to camera modules 120, detect button presses, read the battery level, and toggle illumination of indication LED board 132. The computer module hosts software that initializes the electronics, streams 4 k video captured by camera modules 120, creates “super resolution” images by combining images from the plurality of camera modules 120, and hosts a plurality of network servers, preferably including a screen video streaming server; a Wi-Fi video streaming server; a media server that transfers images and video files (recorded) to screen 116; and a control server that enables touchscreen control of camera head 104 from screen 116. (As used herein, super resolution means a higher resolution image of a target computed from multiple lower resolution images of the same target in which each of the lower resolution image differs slightly in perspective from each of the other lower resolution images.) Additionally or alternatively, images and videos may be sent, after being recorded or, preferably, in real time, to any other suitable viewing device, including a heads up display for the user or another monitoring station.

As noted, camera head 104 is preferably attached to the distal end of pole 108 via gimbal mechanism 110, or another suitable mechanism for allowing camera head 104 to be rotated or swiveled. Pole 108 may include a series of nesting carbon fiber tubes connected by friction locks to enable length adjustment of pole 108. Within pole 108 are two nested coiled cables for transferring power, interface, and high-speed data from screen 116 (attached to pole 108 near the proximal end) to camera head 104. In addition, or alternatively, other components, such as ribbon cable, shielded flat flex, and standard flat flex, may be used for these connections.

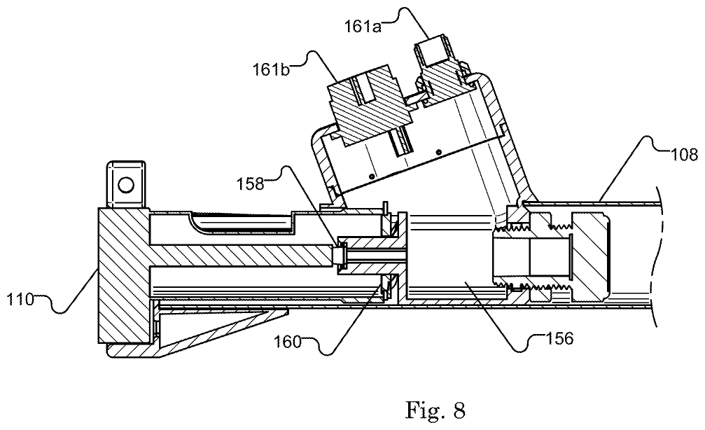

On the distal end of pole 108 (shown in FIG. 8), gimbal mechanism 110 is attached to pole 108 through a battery contact plug 156 that is situated in pole 108 and includes a positive battery terminal 158 and brass washer 160. This adapter system provides a power interface that connects to the electronic components of gimbal mechanism 110. In addition, one or more ports 161 (e.g., 161a, 161b) are configured to allow a flexible wire or cable 163 (e.g., 163a, 163b as shown in FIG. 1) to connect to corresponding ports (e.g., 121, 123) on camera hear 104 without being affected by or interfering with the rotation of camera head 104. Alternatively, the cabling connecting pole 108 to camera head 104 is routed internally via bulkheads.

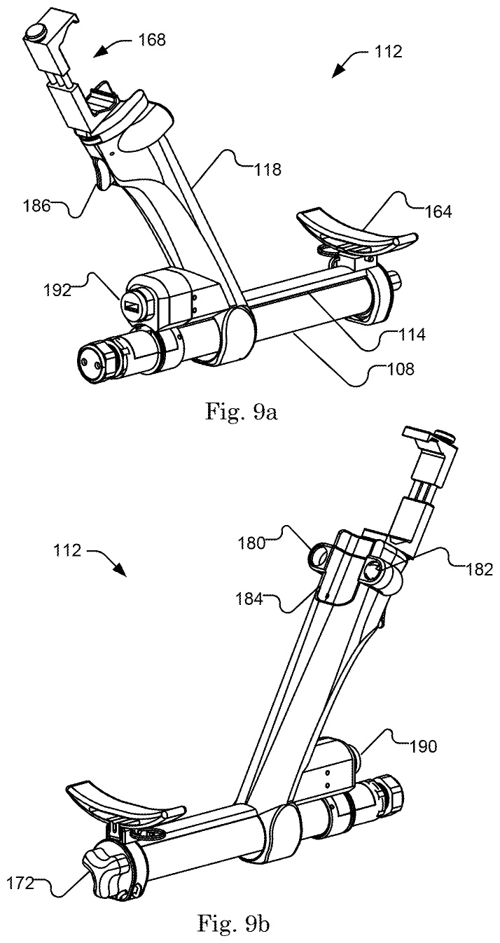

Turning to FIGS. 9A-9B, handle 112 attaches near the proximal end of pole 108 and includes a base 114, grip 118, and an arm support 164. Grip 118 extends outwardly from base 114, preferably such that grip 118 angles toward camera head 104 (i.e., forming a slightly acute angle with the distal portion of pole 108). Arm support 164 is preferably on the proximal end of base 114 and can help a user support/balance the weight of system 100 when holding during use. In a preferred embodiment, arm support 164 and handle 112 are sized and configured for a user engaged in bomb-suit operations.

A screen holder 168 extends from grip 118 and includes a captured thumb-screw that fastens screen 116 (shown attached in FIG. 1, not shown in FIGS. 9A-9B) in place. When screen 116 is fastened to screen holder 168, the height of grip 118 is designed such that screen 116 remains visible to a user wearing a bomb suit, even when pole 108 is not angled upward from the vertical.

Several controls may be located on handle 112 for controlling the functions of camera head 104, including capturing images, operating gimbal mechanism 110 to change the orientation of camera head 104, activating the LEDs, etc. A portion of handle 112 that interfaces with extendable pole 108 may also contain a power source for system 100, such as batteries. A hatch 172 on the distal end of handle 112 opens to enable a battery cavity to be accessed. In addition, grip 118 may include a trigger function rocker switch 180, a master power on/off rocker switch 182, a cutout for mode function button 184 (which can be seen in FIG. 9B), and a trigger 186. Base 114 may include a threaded hole for strain relief, a contact plug for power/button presses, and a cutout 190 for a high-speed data connection, such as a USB tether. In addition, a wire run connects controls on grip 118 to a positive battery contact. Another wire run connects a negative battery contact to the positive battery contact. Handle 112 may also include a mounting location for a current switch, a panel mount for power and control, and a temperature sensor cutout for the thermal switch.

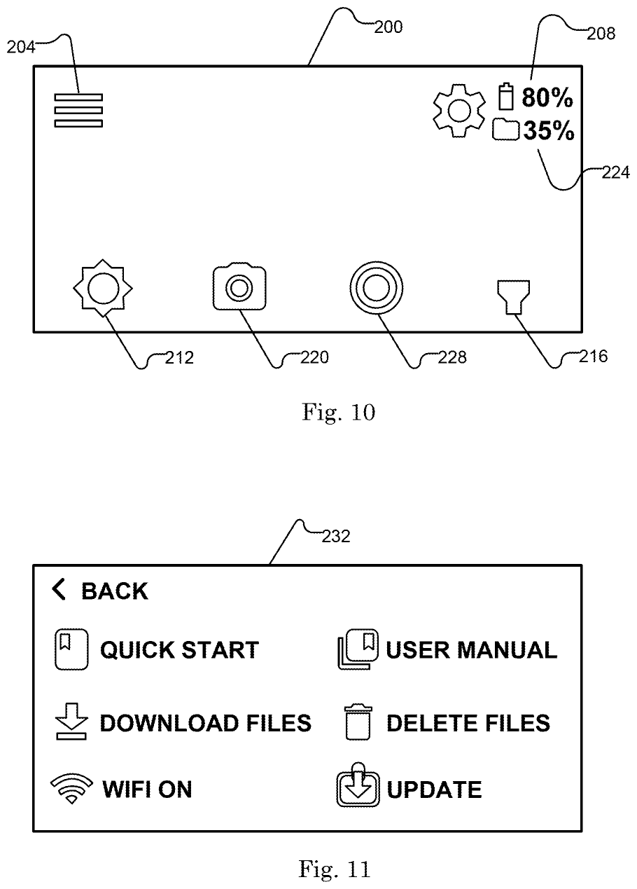

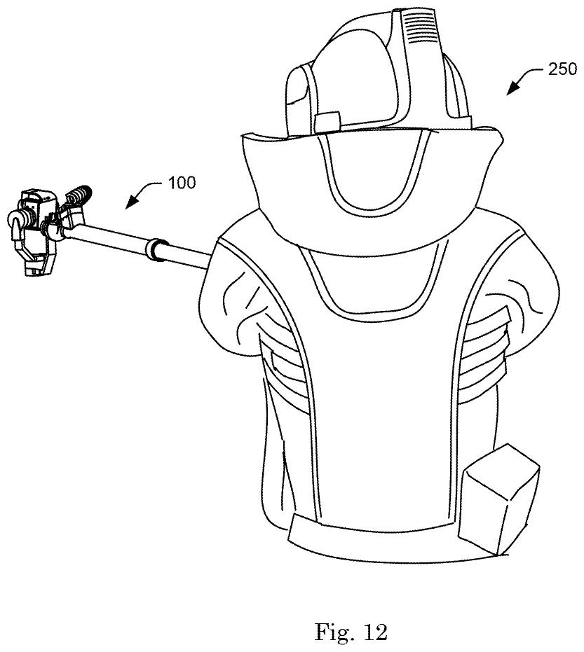

Any suitable device may be used for screen 116, which hosts an app designed to connect to the plurality of servers in camera head 104. The app enables touch-screen control and provides video feedback to the user. FIG. 10 depicts an exemplary interface 200 for screen 116, and includes controls such as a Hide User Interface option 204, transfer image or video to phone or other device, battery level indicator 208, IR LED indicator/activator 212, white LED indicator 216, image capture 220, remaining memory 224, and record video indicator/activator 228. A menu option 228 provides a menu 232 as shown in FIG. 11, which may include information such as quick start guide, user manual, set up, as well as functions such as WiFi On/Off, download files, delete files, and get updates. In addition, the main page and/or menu option page may include an option for sending images and videos to other devices.

In operation, a user 250 as shown in FIG. 12 may be in a bomb suit assembles a multi-aperture pole camera system if needed and adjusts the pole to a desired length. The main power switch is toggled on and a connection is established between the camera portion and the screen, which may be indicated by a chirp or other signal. The user holds the pole and points the camera head at desired targets/scenes and uses buttons on the grip and/or touch screen to actuate image capture, LEDs, etc. as well as to adjust the orientation of the camera head. The user can transfer images and/or video to the screen (e.g., a phone) by pressing a file transfer button. The user can send (via email, Wi-Fi, Bluetooth, text, etc.) data to another device for viewing, further analysis, or archiving. Additionally or alternatively, the camera head may include a processor that evaluates images taken by the camera modules and classifies items encountered (via a machine learning or other suitable technique) such that items of interest can be automatically identified in real time. A warning or alert may be provided to the user.

In this way, the multi-aperture camera system may be used as an inspection and screening tool with which users extend their view, especially in dark spaces, tight spaces, hard to reach spaces, and/or potentially hazardous places. Example uses include viewing vehicle undercarriages, looking behind and under furniture, and looking up and over objects, as well as to inspect the interior of an object, such as a drawer or cabinet.

Additional uses include the generation of data for analysis because 52 Mpix images and 4 k video can be collected with the multi-aperture camera. The super resolution 52 Mpix images may be used to discern the specifics of a threat. 4K video could be used to re-play events during a screening for after-action analysis and training purposes.

Also, the multi-aperture camera system may be used as a situational awareness tool with which users can simulcast video via Wi-Fi in real-time. In this way, selected others can observe the same video as the operator of the camera system. This enables others up-range from the operator to help identify targets or other images of interest.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for facilitating a visual inspection, the system comprising:
a pole, the pole being extendable and having a distal end and a proximal end;
a gimbal attached to the distal end of the pole;
a handle on the proximal end of the pole, the handle including:
an arm support; and
a grip extending at an angle out from the pole, the grip including a plurality of controls and a screen support; and
a camera head attached to the gimbal, the camera head including:
a plurality of camera modules; and
an interface board,
wherein at least some functions of the camera head are controlled by the plurality of controls, and wherein images captured by the plurality of camera modules are sent through the pole to a data port near the handle.

2. The system of claim 1, wherein the camera head further includes a compression stack.

3. The system of claim 2, further including an enclosure around the camera head, and wherein the camera head further includes a first heat sink, the first heat sink extending through the enclosure and between at least some of the plurality of camera modules.

4. The system of claim 3, further including a gimbal mount connecting the camera head to the gimbal and a second heat sink, the second heat sink being thermally connected to the gimbal mount.

5. The system of claim 4, wherein the camera head further includes an interface board, a plurality of illumination LEDs, and a high-speed data interface.

6. The system of claim 5, wherein the plurality of camera modules, the interface board, the plurality of illumination LEDs, the first heat sink, and the second heat sink are mechanically interfaced only with compression.

7. The system of claim 1, wherein the plurality of camera modules includes four camera modules, and the interface board includes a computer module that includes instructions for:
initializing electrical components;
streaming 4 k video; and
creating super resolution images by combining images from the four camera modules.

8. The system of claim 1, wherein the handle and the camera head are connected via internal cabling.

9. The system of claim 5, wherein the functions include capturing images, changing an orientation of the camera head, and activating the plurality of illumination LEDs.

10. The system of claim 1, wherein each of the plurality of camera modules includes a transparent lens protector.

11. The system of claim 1, further including a screen attached to the screen support, wherein images from the plurality of camera modules are displayed on the screen.

12. The system of claim 1, wherein images from the plurality of camera modules are displayed on a heads up display worn by a user of the system.

13. The system of claim 1, wherein the plurality of camera modules includes three color cameras and one IR camera.

14. The system of claim 1, wherein the camera head includes a gimbal attachment portion configured to fit in a slot in the gimbal, and wherein the gimbal attachment portion is secured in the slot with a pin.

15. A camera head for facilitating a visual inspection, the camera head comprising:
an enclosure containing:
a camera module;
a plurality of lights for illuminating an area for the camera module;
a high-speed data interface;
a heatsink component;
an interface board including a computer module, wherein the interface board is in communication with the camera module, the plurality of lights, and the high-speed data interface; and
a compression stack, wherein the camera module, the interface board, the heatsink component, and the plurality of lights are mechanically interfaced only with compression; and
a gimbal connector, wherein the gimbal connecter passes through the enclosure and is in thermal contact with the heatsink component.

16. The camera head of claim 15, further including a second heatsink, wherein the second heatsink extends through the enclosure near the camera module.

17. The camera head of claim 15, wherein a USB connector protrudes from the enclosure.

18. The camera head of claim 17, wherein the enclosure further contains an indication board for the plurality of lights, a remote-control interface, a USB connector, a single board computing device, a USB C board, and a USB A board.

19. A system for facilitating a visual inspection, the system comprising:
a pole, the pole being extendable and having a distal end and a proximal end;
a handle on the proximal end of the pole, the handle including a grip and an arm support, wherein the grip extends at an angle outwardly from the pole; and
a camera head in an enclosure and pivotably attached to the distal end of the pole, the camera head including:
a camera module;
a heat sink extending through the enclosure;
a compression stack;
a light positioned to illuminate areas in view of the camera module; and
an interface board, wherein the camera module, the interface board, the light, and the heat sink are mechanically interfaced only by compression within the enclosure.

20. The system of claim 19, further including a screen support attached to the grip, the screen support configured to secure a screen on which images from the camera module are displayed, and wherein the light is an IR light.
